(19) United States
(12) Patent Application Publication
(10) Pub. No.: US 2026/0268396 A1
(43) Pub. Date: Sep. 10, 2026

(54) AI and Smart Contract-Based Autonomous Banking System

(71) Applicant: FURONG BEI, San Gabriel, CA (US)

(72) Inventor: FURONG BEI, San Gabriel, CA (US)

(21) Appl. No.: 19/074,352

(22) Filed: Mar. 8, 2025

(51) Int. Cl. G06Q 40/02; G06F 8/65; G06Q 10/04; G06Q 20/38; G06Q 20/40; G06Q 40/03; G06Q 40/08

(52) U.S. Cl. CPC G06Q 40/02; G06F 8/65; G06Q 10/04; G06Q 20/3825; G06Q 20/389; G06Q 20/40145; G06Q 20/4016; G06Q 40/03; G06Q 40/08; G06Q 2220/00; G06Q 2230/00

(57) ABSTRACT

This invention describes a novel AI-driven autonomous banking and asset tokenization system that integrates blockchain, smart contracts, decentralized governance, and cross-chain interoperability. The system autonomously tokenizes assets, fractionalizes them into NFTs, manages collateralized loans, performs real-time risk assessments, and ensures regulatory compliance using artificial intelligence without continuous human intervention. Through dynamic AI modeling, multi-signature security, and decentralized decision-making, the invention enables secure, transparent, and efficient financial and asset operations across heterogeneous blockchain networks.

### I. FIELD OF THE INVENTION

The present invention relates generally to the fields of financial technology (FinTech), blockchain, decentralized finance (DeFi), and artificial intelligence (AI). More specifically, it pertains to a novel integrated system and method for establishing an autonomous banking framework that facilitates the secure, transparent, and compliant tokenization, fractionalization, management, and cross-chain transfer of diverse assets, dynamically governed and optimized by artificial intelligence, without requiring continuous human intervention.

### II. BACKGROUND OF THE INVENTION

The global financial landscape is undergoing a profound transformation driven by blockchain technology and the increasing digitalization of assets. Despite significant advancements, several critical challenges persist in both traditional and nascent decentralized financial systems:
A. Illiquidity of High-Value Assets: High-value tangible assets (e.g., real estate, fine art, luxury goods) and intangible assets (e.g., intellectual property, private equity shares) traditionally suffer from severe illiquidity due to high entry barriers, large indivisible denominations, and cumbersome transfer processes. Existing tokenization efforts often lack robust fractionalization mechanisms that enable seamless and compliant secondary market trading.
B. Lack of Interoperability in Blockchain Ecosystems: The proliferation of disparate blockchain networks (e.g., Ethereum, Polygon, Solana, Avalanche) has led to fragmented liquidity and limited asset portability. Current cross-chain solutions frequently present security vulnerabilities, high transaction costs, and operational complexities, hindering true universal asset management.
C. Limitations of Current Decentralized Finance (Defi): While Defi has revolutionized financial services through smart contracts, many platforms still rely on manual or semi-manual risk assessment, governance decisions, and compliance enforcement. This introduces human biases, delays, and inefficiencies, limiting scalability and robust risk management, particularly in volatile markets. Furthermore, the integration of regulatory compliance (e.g., Know Your Customer (KYC) and Anti-Money Laundering (AML)) in DeFi remains a significant hurdle for widespread adoption by institutional players and regulated entities.
D. Absence of Autonomous Financial Operations: A fully autonomous banking system that can intelligently and dynamically perform core financial services (e.g., loan issuance, collateral management, interest rate adjustments, settlements) without continuous human oversight, while simultaneously adapting to real-time market conditions and regulatory changes, has remained an elusive goal. Existing systems either lack the necessary AI-driven intelligence for dynamic adaptation or the robust blockchain infrastructure for transparent and immutable record-keeping and execution.

Therefore, there is a compelling need for an integrated, intelligent, and autonomous system that seamlessly blends AI capabilities with blockchain's decentralization, NFT's unique asset representation, and robust cross-chain interoperability to create a secure, liquid, and compliant digital banking paradigm.

### III. SUMMARY OF THE INVENTION

The present invention overcomes the aforementioned challenges by providing an AI-Driven Autonomous Banking and Asset Tokenization System. This system constitutes a novel integration of a decentralized blockchain ledger, an advanced Artificial Intelligence (AI) module, an asset tokenization and fragmentation module, a smart contract execution layer, and a dynamic governance module.

In one embodiment, the system operates as a self-governing financial entity that autonomously performs financial services, including but not limited to loan issuance, collateral management, repayment processing, settlement, and compliance checks. The AI module continuously analyzes vast datasets (both on-chain and off-chain) to dynamically assess risk, value assets, detect anomalies, and inform decision-making processes that are then executed via smart contracts.

This allows for the precise fractionalization of diverse assets into NFTs, which serve as highly liquid collateral and investment instruments transferable across multiple blockchain networks through secure cross-chain interoperability modules.

The governance of the system is decentralized, utilizing token-weighted voting and multi-signature validation to manage protocol updates, system parameters, and critical cross-chain operations, all while incorporating AI-driven proposal generation for efficiency and security.

This synergistic integration allows the system to operate with unparalleled autonomy, security, transparency, and adaptability, addressing critical needs for liquidity, compliance, and automated risk management in the evolving digital economy.

### IV. BRIEF DESCRIPTION OF THE DRAWINGS

FIG. 1: Illustrates a high-level architectural diagram of the integrated AI-Driven Autonomous Banking and Asset Tokenization System, depicting the primary modules and their interconnections.

FIG. 2: Presents a detailed flowchart of the automated loan issuance and collateral management process, highlighting the roles of the AI module and smart contract execution layer.

FIG. 3: Shows the operational flow for asset tokenization, NFT fragmentation, and subsequent dynamic trading within the system, including interaction with decentralized exchanges.

FIG. 4: Depicts the security and cross-chain interoperability framework, illustrating the multi-signature protocols, cross-chain bridge mechanisms, and anomaly detection system.

FIG. 5: Outlines the decentralized governance process, detailing the token-weighted voting, multi-signature validation, and AI-driven proposal generation.

FIG. 6: Illustrates the integrated compliance workflow, including decentralized KYC/AML checks using zero-knowledge proofs and the generation of immutable on-chain audit reports.

### V. DETAILED DESCRIPTION OF THE INVENTION

The present invention describes an AI-Driven Autonomous Banking and Asset Tokenization System designed to operate with minimal to no human intervention, facilitating a new paradigm for digital finance.

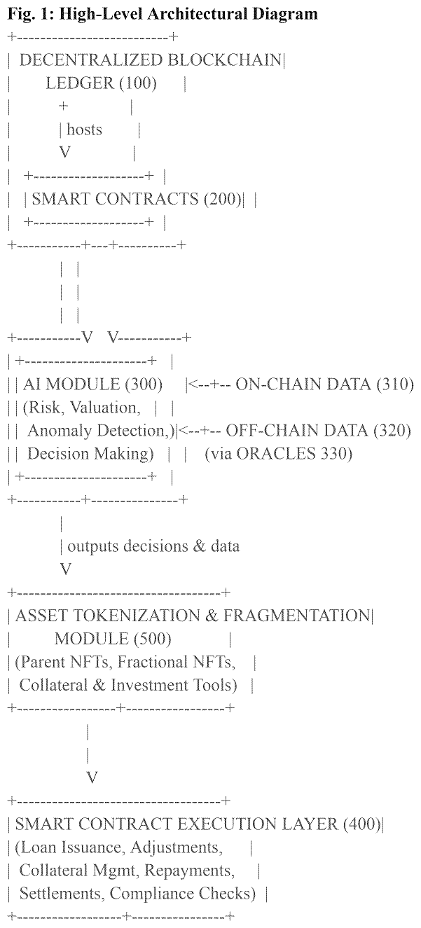

### A. System Architecture (Referring to FIG. 1)

The core of the system is built upon a decentralized blockchain ledger (100), which provides an immutable and transparent record-keeping layer. This ledger hosts a series of interconnected smart contracts (200) that define and execute the system's financial and asset management logic. The system further comprises:
1. Artificial Intelligence (AI) Module (300): This is the intelligent core of the system, designed for continuous learning and dynamic adaptation. The AI Module (300) is configured to analyze vast quantities of both on-chain data (310) (e.g., transaction history, token prices, liquidity pool depths, smart contract states) and off-chain data (320) (e.g., traditional market data, credit scores from decentralized identity providers, macroeconomic indicators supplied via secure oracle networks (330)). The AI module employs various machine learning models, including but not limited to:
   Risk Assessment Models: Utilizing recurrent neural networks (RNNs) or deep reinforcement learning to identify patterns of fraudulent activity, predict default probabilities for loan applicants, and assess overall market volatility. For example, it can analyze historical loan repayment data, borrower on-chain behavior, and cross-chain transaction patterns to compute a dynamic creditworthiness score.
   Asset Valuation Models: Employing convolutional neural networks (CNNs) for image-based asset valuation (e.g., art NFTs) or gradient boosting models for financial securities, continuously updating the fair market value of tokenized assets based on real-time supply/demand, comparable sales data, and external market trends.
   Anomaly Detection Models: Using unsupervised learning techniques (e.g., Isolation Forests or Autoencoders) to identify unusual transaction patterns, potential security breaches, or system manipulations that deviate from established norms.
   Decision-Making Engines: Incorporating reinforcement learning agents that learn optimal strategies for adjusting loan terms, interest rates, and collateral requirements in response to changing market conditions and calculated risk profiles, aiming to maximize system stability and profitability while minimizing losses.

The AI module's outputs are fed directly to the smart contract execution layer (400) or the governance module (600) for automated execution or proposal generation.
2. Asset Tokenization and Fragmentation Module (500): This module facilitates the representation of diverse real-world and digital assets on the blockchain.
   Parent Tokenization: Physical assets (e.g., real estate, legal deeds, artwork certificates) and digital assets (e.g., intellectual property rights, digital art, software licenses) are converted into unique, non-fungible parent NFTs (ERC-721 or ERC-1155 compliant). Comprehensive metadata, including legal ownership proofs, asset specifications, and appraisal reports, is stored immutably on decentralized storage networks (e.g., IPFS, Arweave), with cryptographic hashes embedded within the parent NFT for verifiable integrity.
   Fractionalization: The parent NFT can then be programmatically divided into a predefined number of fractional NFTs (e.g., ERC-20 or ERC-1155 tokens with unique identifiers), each representing a precise, granular share of the underlying asset's ownership or value. This module ensures that the sum of all fractional NFTs precisely equals the value or ownership of the parent NFT, maintaining cryptographic integrity.
   Collateral & Investment Instruments: These fractional NFTs serve as highly liquid collateral for loans issued by the system and as accessible investment instruments for a broad range of investors.
   Merging Functionality: The module also supports the re-merging of fragmented NFTs back into the original parent NFT if an entity acquires a complete set of the fractional shares, subject to ownership verification and smart contract execution.
3. Smart Contract Execution Layer (400): This layer comprises a suite of audited smart contracts deployed on the blockchain ledger (100). These contracts autonomously perform core financial services based on decisions and data inputs from the AI module (300) and user interactions.
   Loan Issuance and Adjustment: Smart contracts automatically issue loans based on AI-calculated creditworthiness and dynamic asset valuations. Loan terms (e.g., interest rates, repayment schedules, collateral ratios) are autonomously adjusted in real-time by the smart contracts in response to changes in market conditions, borrower risk scores, and collateral value as determined by the AI module.
   Collateral Management: Automated smart contracts manage collateral (NFTs) by locking them when a loan is issued and releasing them upon full repayment. In case of loan default or collateral value falling below a predefined threshold, the contracts autonomously trigger liquidation mechanisms, such as automated collateral auctions or re-fractionalization for sale.
   Repayment and Settlements: Smart contracts facilitate automated repayment processing and atomic settlements for all financial transactions, including loan principal and interest, fees, and cross-chain clearings, eliminating counterparty risk.
   Dynamic Trading: Smart contracts within this layer power decentralized exchanges (DEXs) for fragmented NFTs, utilizing an Automated Market Maker (AMM) model that dynamically updates asset prices based on the AI module's pricing algorithm and real-time liquidity conditions.
4. Governance Module (600): The system's evolution and critical operations are managed by a decentralized governance module, ensuring community oversight and resilience against single points of failure.
   Token-Weighted Voting (610): Participants holding designated governance tokens can submit and vote on proposals related to system upgrades, parameter changes (e.g., fee structures, supported assets), and treasury management. Voting power is proportional to the amount of governance tokens held. Accepted proposals are automatically executed by smart contracts (400) without manual intervention.
   Multi-Signature Validation (620): For critical system updates, smart contract deployments, or large asset transfers (especially cross-chain), multi-signature protocols are enforced. This requires a predefined minimum number of authorized key holders to approve a transaction before it can be executed, providing an additional layer of security and decentralization.
   AI-Driven Proposal Engine (630): The AI module (300) proactively identifies potential vulnerabilities, recommends protocol upgrades based on security audits and performance analysis, and suggests optimal asset allocation or valuation updates. These insights are automatically converted into formal proposals and submitted to the community for token-weighted voting (610). This ensures continuous system optimization and responsiveness to emerging threats or opportunities.

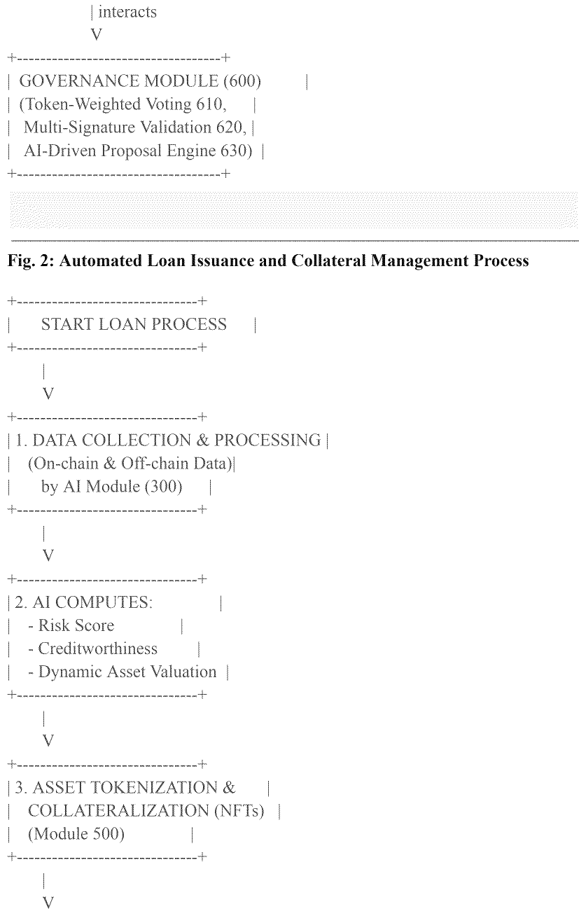

### B. Method of Operation (Referring to FIG. 2)

A computer-implemented method for automated financial and asset management is performed as follows:
1. Data Collection and Processing (210): The AI module (300) continuously collects and processes comprehensive data. This includes:
   On-chain data (e.g., blockchain transaction logs, smart contract states, token prices, liquidity pool activities, NFT ownership transfers).
   Off-chain data (e.g., traditional financial market data, credit bureau information (via secure oracles), macroeconomic indicators, real-world asset appraisal reports).
   This data undergoes cleaning, normalization, and feature engineering to prepare it for AI model training and inference.
2. Risk Assessment, Creditworthiness & Valuation (220): The AI module (300) computes several critical metrics in real-time:
   Risk Score: An aggregate score representing the likelihood of default for a borrower or the risk associated with a specific asset class or transaction.
   Creditworthiness Evaluation: An assessment of a borrower's ability and willingness to repay, based on their on-chain behavior, linked decentralized identity (DID) data, and AI analysis.
   Dynamic Asset Valuation: Continuous re-appraisal of tokenized assets (NFTs) to reflect their current market value, accounting for liquidity, demand, and external factors.
3. Asset Tokenization and Collateralization (230): Assets are tokenized into NFTs and made available for use as collateral for loans. This involves the Asset Tokenization and Fragmentation Module (500) creating parent NFTs and/or fractional NFTs.
4. Automated Loan Management (240): Based on the evaluation results from the AI module (300), smart contracts (400) automatically:
   Issue Loans: If a borrower's creditworthiness meets predefined criteria and sufficient collateral (NFTs) is provided.
   Adjust Loan Terms: Dynamically modify interest rates, collateral ratios, and repayment schedules in response to changes in risk scores, collateral value, or market conditions, aiming for system stability.
   Settle Loans: Automatically process repayments and release collateral upon loan fulfillment.
5. Automated Compliance and Reporting (250): The Compliance Module (700) performs automated checks and reporting:
   Decentralized KYC/AML: At onboarding or during specific high-value transactions, user identities are verified through a decentralized identity (DID) system utilizing zero-knowledge proofs (ZKPs). This allows the system to confirm required identity attributes (e.g., age verification, country of origin) without revealing underlying personal data, ensuring privacy while meeting regulatory demands.
   Regulatory Checks: Smart contracts are configured with pre-defined rules to ensure transactions adhere to relevant financial regulations (e.g., transaction limits, restricted jurisdictions).
   Immutable Reporting: All actions, results, and asset records (including loan originations, collateral liquidations, and compliance checks) are automatically generated as immutable reports and stored directly on the blockchain (100) for transparency, auditability, and regulatory compliance.
6. Blockchain Storage for Transparency and Interoperability (260): All actions, results, and asset records are permanently stored on the decentralized blockchain ledger (100). This provides an auditable public record and facilitates seamless cross-chain interoperability by providing a consistent and verifiable source of truth for asset ownership and transaction history across different blockchain networks (as further detailed in Section E).

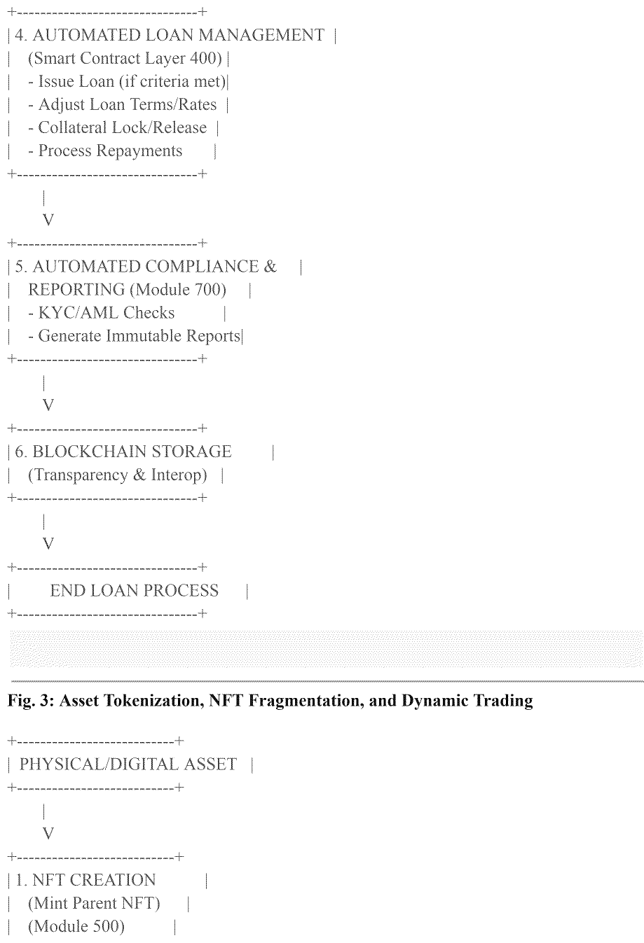

### C. Asset Management and Trading Operations (Referring to FIG. 3)

The system robustly supports asset tokenization, fractionalization, and dynamic trading:
1. NFT Creation and Fractionalization (310): This involves minting parent NFTs for whole assets and subsequently breaking them down into fractional NFTs, which are unique and represent distinct shares of ownership. This process is governed by immutable smart contracts ensuring cryptographic integrity and verifiable ownership.
2. Dynamic Trading and Liquidity Pools (320):
   Fractional NFTs can be listed on decentralized exchanges powered by the system's smart contract execution layer (400).
   An AI-driven liquidity optimizer (340) dynamically allocates capital reserves and collateral pools across various asset classes and cross-chain bridges to ensure optimal liquidity and minimize slippage. This optimizer analyzes real-time gas fees, network congestion, and cross-chain bridge utilization to route transactions efficiently.
   Prices are continuously determined by the AI module's dynamic pricing algorithm, adapting to supply, demand, and market volatility.
3. NFT Merging and Redemption (350): Holders of all fractional NFTs corresponding to a parent asset can initiate a smart contract function to burn the fragments and redeem the original parent NFT, providing flexibility in asset management.

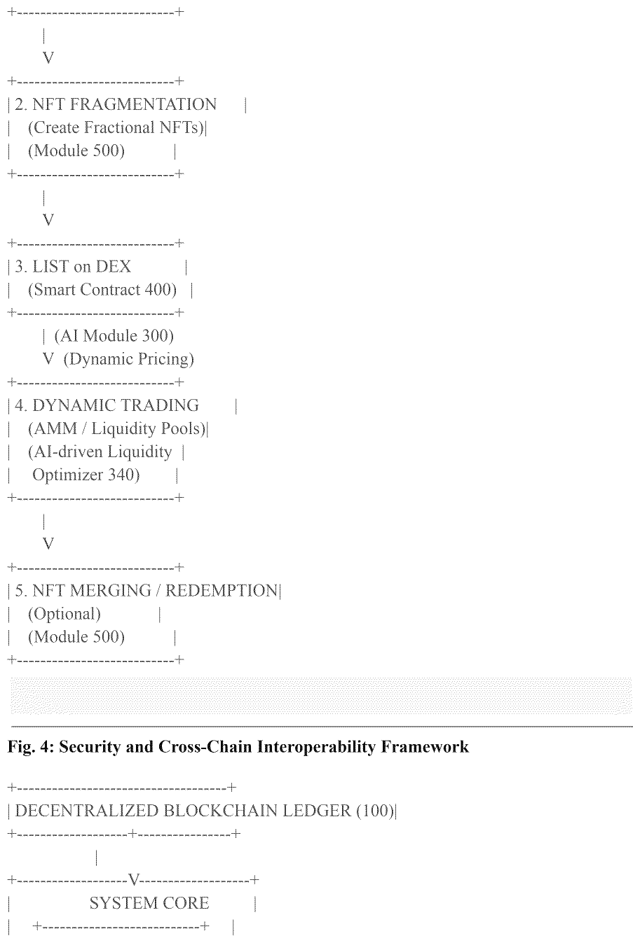

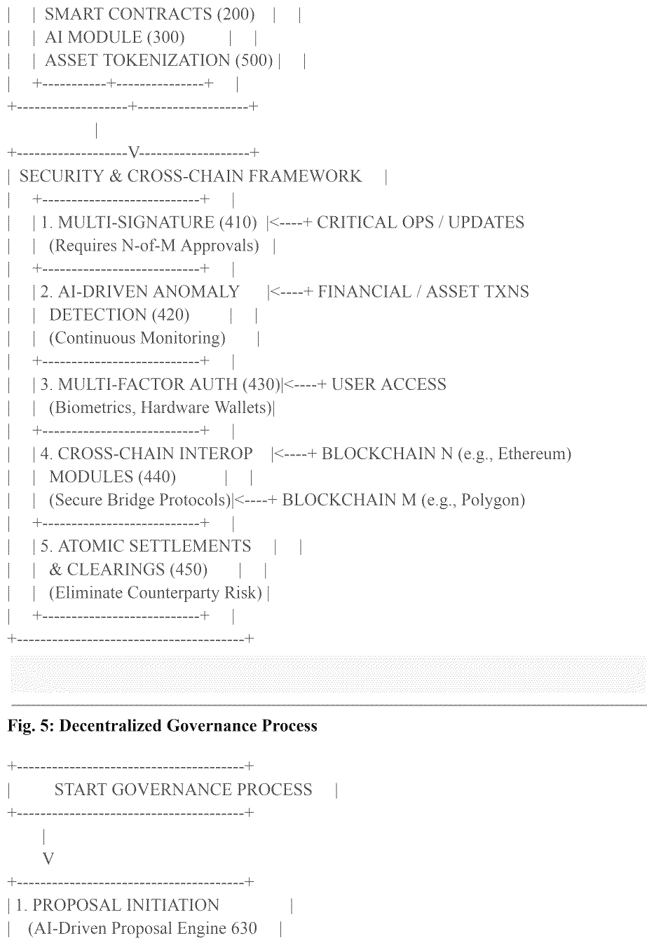

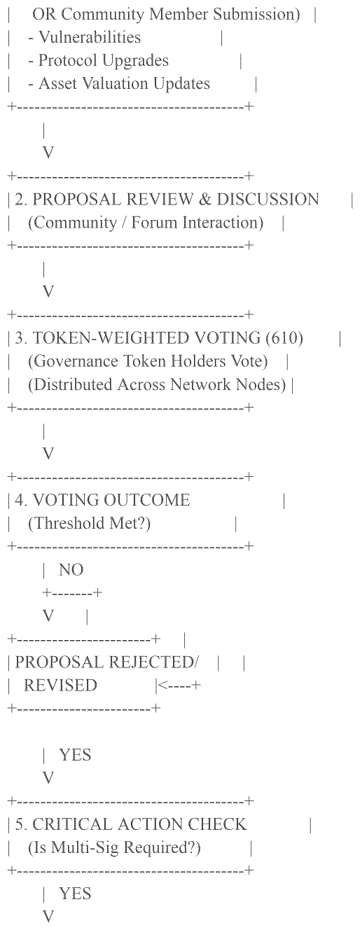

### D. Security and Anomaly Detection (Referring to FIG. 4)

Security is paramount in the system's design:
1. Multi-Signature Protocols (410): Critical operations, such as system upgrades, smart contract parameter changes, and large asset movements (especially across chains), require multi-signature approval from a predefined quorum of trusted validators or governance token holders. This prevents unauthorized access and manipulation.
2. AI-Driven Anomaly Detection (420): The AI module (300) includes an advanced anomaly detection engine that continuously monitors all financial and asset-related transactions across the system and connected blockchain networks. This engine utilizes ensemble AI models (e.g., combining unsupervised learning for outlier detection with supervised learning trained on known fraud patterns) to identify suspicious activities in real-time. Upon detection of an anomaly (e.g., unusual transaction volume, rapid asset price manipulation, unauthorized access attempts), the system can automatically trigger predefined responses, such as pausing transactions, freezing suspicious accounts, or generating alerts for governance review.
3. Multi-Factor Authentication (MFA) (430): User access to sensitive features integrates multi-factor authentication, including cryptographic keys, hardware wallets, and optionally biometric authentication (e.g., fingerprint, facial recognition) linked to decentralized identity (DID) credentials, further securing user accounts.

### E. Cross-chain Interoperability (referring to FIG. 4)

The system supports seamless asset and data transfer across heterogeneous blockchain networks:
1. Cross-Chain Interoperability Modules (440): These modules utilize secure bridge protocols (e.g., wrapped token standards, state channels, relay networks, or atomic swap mechanisms) to enable the movement of tokenized assets and the synchronization of loan and ownership records between different blockchains.
2. Atomic Settlements and Clearings (450): Cross-chain smart contracts execute settlements and clearings atomically, ensuring that transactions are either fully completed on all involved chains or entirely rolled back, thereby eliminating counterparty risk in multi-chain environments. This is crucial for maintaining the integrity of collateralized loans and asset ownership across diverse networks.

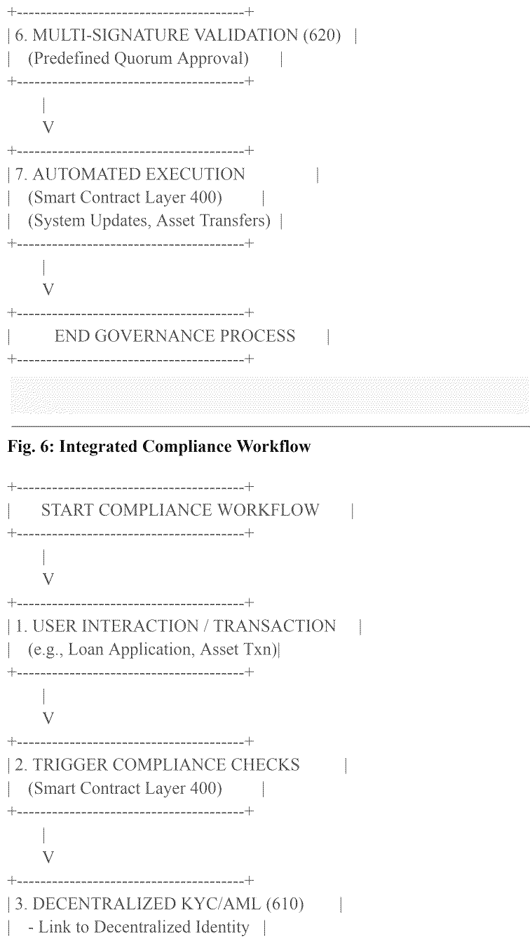

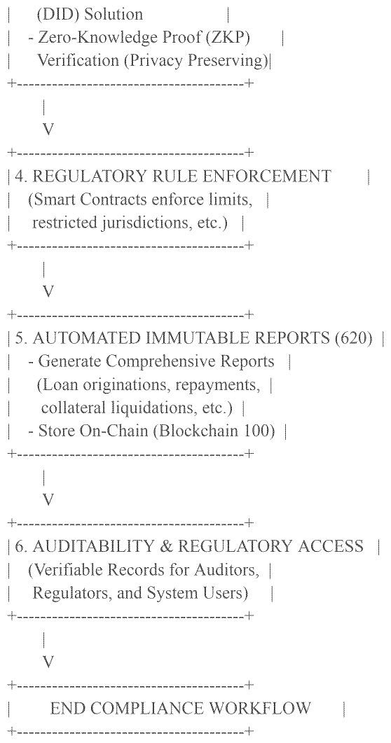

### F. Compliance and Reporting (Referring to FIG. 6)

A robust compliance framework is integrated:
1. Decentralized KYC/AML (610): The system integrates with decentralized identity (DID) solutions. Users can prove their compliance (e.g., age, nationality, non-sanctioned status) using Zero-Knowledge Proofs (ZKPs), without revealing their underlying sensitive personal data. This enables the system to meet regulatory requirements while preserving user privacy.
2. Automated Immutable Reports (620): The system automatically generates comprehensive, immutable reports of all loan origination, repayment, collateral management, and asset transfer operations. These reports are stored on the blockchain ledger (100) as verifiable records, readily available for internal audits, external regulatory bodies, and compliance officers, greatly simplifying reporting burdens.

### G. Additional Features and Advantages

1. AI Stress Scenarios (Dependent Claim 12): The AI module can periodically simulate stress scenarios on asset-backed loan portfolios (e.g., sudden market crashes, liquidity

1. An autonomous banking system comprising a blockchain layer, AI module, and smart contract execution layer to perform self-operated financial services without human intervention.

2. A method for automated loan issuance using AI-driven risk assessment and smart contract execution.

3. A security mechanism utilizing multi-signature protocols and AI-based anomaly detection to ensure secure financial transactions.

4. A dynamic governance model based on token-weighted voting and multi-node validation for approving system updates.

5. A self-evolving mechanism wherein the AI module proposes system updates and vulnerability patches for governance approval.
(Include up to 20 claims covering each unique feature of the system)

6. The system of Claim 1, wherein the AI module includes anomaly detection algorithms that continuously monitor transaction patterns to identify and prevent fraudulent activities.

7. The system of claim 1, further comprising an AI-driven self-update mechanism that autonomously identifies security vulnerabilities and proposes patches for governance approval.

8. The system of claim 5, wherein the governance model includes a weighted voting mechanism allowing 1 token to represent multiple votes for critical system decisions.

9. The system of claim 1, wherein smart contracts execute automated settlements by verifying transaction conditions and transferring assets upon fulfillment.

10. The system of claim 1, further comprising an AI-based predictive analytics module that forecasts financial risks and optimizes interest rates dynamically.

11. The system of claim 1, wherein the blockchain layer ensures immutability and transparency of all financial transactions through a distributed ledger.

12. The system of claim 1, further comprising a decentralized identity verification mechanism using zero-knowledge proofs to protect user privacy.

13. The system of claim 1, wherein the AI module employs machine learning algorithms to enhance risk assessment accuracy over time.

14. The system of claim 1, further comprising a cross-chain interoperability protocol that allows integration and transactions between different blockchain networks.

15. The system of claim 1, wherein smart contracts are programmable to enforce regulatory compliance automatically, including Anti-Money Laundering (AML) and Know Your Customer (KYC) requirements.

16. The system of claim 1, further comprising a decentralized oracle mechanism to fetch real-time off-chain data for accurate AI analysis and smart contract execution.

17. The system of claim 1, wherein a staking mechanism is implemented, allowing users to lock tokens to participate in governance and earn rewards.

18. The system of claim 1, further comprising a decentralized insurance protocol managed by smart contracts to cover risks associated with loans and financial transactions.

19. The system of claim 1, wherein the AI module includes natural language processing capabilities to interpret and execute user commands for financial transactions.

20. The system of claim 1, further comprising a tiered security protocol that includes multi-factor authentication, biometric verification, and AI-based risk scoring for access control.
